(19) United States
(12) Patent Application Publication
(10) Pub. No.: US 2006/0187944 A1
(43) Pub. Date: Aug. 24, 2006

(54) Communication device, data transferring system and electronic apparatus

(76) Inventors: Koji Takeo, Miyagi (JP); Noriyuki Terao, Miyagi (JP); Junichi Ikeda, Miyagi (JP); Koji Oshikiri, Miyagi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/336,863

(22) Filed: Jan. 23, 2006

(30) Foreign Application Priority Data
Jan. 31, 2005 (JP) 2005-023687

(51) Int. Cl. H04J 3/16; H04L 12/56; H04L 12/28; H04J 3/22

(52) U.S. Cl. 370/408; 370/469

(57) ABSTRACT

A data transferring system in which detecting a route from an upper position to a lower position on a tree structure is realized by hardware of communication devices and processes for detecting the above are simplified is disclosed. A root complex broadcasts a search message to a lower node on a tree structure. When a port of the node confirms and receives the search message, the port adds its own information, specifically, the device number of the port, to the data payload part of the search message and sends the search message including the information to a node (end point) located at the lowest position on the tree structure. When the end point receives the search message, the end point sends a reply message to the root complex. The device numbers of the ports where the search message passes through are attached to the reply message.

### BACKGROUND OF THE INVENTION

1. Field of the Invention

The present invention generally relates to a communication device, a data transferring system that provides the communication devices and an electronic apparatus that provides the data transferring system.

2. Description of the Related Art

As a high speed serial interface, an interface called PCI Express (peripheral component interconnect express, registered trademark) being a successor of PCI is proposed (for example, refer to Non-Patent Document 1).

[Non-Patent Document 1] Outline of the PCI Express Standard, Interface July 2003, written by Takashi Satomi

In the PCI Express standard, there are settings which must consider values in all links between a root complex and end points, such as a setting of virtual channels and a setting of power saving states.

However, in the PCI Express standard, a method that detects a route from a root complex to an arbitrary end point and a method that detects a communication parameter in the route are not provided. Therefore, there is a problem in that the above detection must be executed by a method, for example, using software.

### SUMMARY OF THE INVENTION

In a preferred embodiment of the present invention, there is provided a communication device, a data transferring system that provides the communication devices and an electronic apparatus that provides the data transferring system, in which a method that detects a route from an upper position to a lower position on a tree structure and a method that detects a communication parameter in the route can be realized by hardware of the communication devices in the data transferring system and processes for detecting the above are simplified.

In the data transferring system, a data transferring route has a tree structure, a connection between nodes on the tree structure is point to point, and communications between the nodes are executed by matching settings between facing ports of the nodes. The present invention is executed in the data transferring system based on, for example, the PCI Express standard.

Features and advantages of the present invention are set forth in the description that follows, and in part will become apparent from the description and the accompanying drawings, or may be learned by practice of the invention according to the teachings provided in the description. Objects as well as other features and advantages of the present invention will be realized and attained by a communication device, a data transferring system that provides the communication devices and an electronic apparatus that provides the data transferring system particularly pointed out in the specification in such full, clear, concise, and exact terms as to enable a person having ordinary skill in the art to practice the invention.

To achieve these and other advantages in accordance with the purpose of the present invention, according to one aspect of the present invention, there is provided a communication device located at the uppermost position on a tree structure in a data transferring system in which a data transferring route has the tree structure, a connection between nodes on the tree structure is point to point, and communications between facing nodes are executed by matching settings between facing ports of the facing nodes. The communication device sends predetermined data to a specific communication device located lower than the communication device on the tree structure, makes the specific communication device add predetermined information of the specific communication device to the predetermined data, and makes the specific communication device send the predetermined data including the predetermined information to a node located lower than the specific communication device.

According to another aspect of the present invention, there is provided a communication device being a node in a data transferring system in which a data transferring route has a tree structure, a connection between nodes on the tree structure is point to point, and communications between facing nodes are executed by matching settings between facing ports of the facing nodes. The node receives data from a communication device located at an upper position on the tree structure, and when the received data are predetermined data, the node adds predetermined information of the node to the predetermined data and sends the predetermined data including the predetermined information to another node located at a lower position on the tree structure.

According to another aspect of the present invention, there is provided a communication device located at the lowest position on a tree structure in a data transferring system in which a data transferring route has the tree structure, a connection between nodes on the tree structure is point to point, and communications between facing nodes are executed by matching settings between facing ports of the facing nodes. The communication device receives predetermined data from a node located at an upper position on the tree structure and when the predetermined data instruct to add predetermined information of the communication device to the predetermined data, the communication device generates data in which the predetermined information is added to the predetermined data and sends the generated data to another communication device located at the uppermost position on the tree structure.

According to another aspect of the present invention, there is provided a communication device located at the uppermost position on a tree structure in a data transferring system in which a data transferring route has the tree structure, a connection between nodes on the tree structure is point to point, and communications between facing nodes are executed by matching settings between facing ports of the facing nodes. The communication device sends predetermined data including a predetermined condition to a specific communication device located lower than the communication device on the tree structure, makes the specific communication device exchange a communication parameter in the predetermined data for a communication parameter of the specific communication device when the communication parameter of the specific communication device matches the predetermined condition by the decision of the specific communication device, and makes the specific communication device send the predetermined data including the exchanged communication parameter to a node located lower than the specific communication device on the tree structure.

According to another aspect of the present invention, there is provided a communication device being a node in a data transferring system in which a data transferring route has a tree structure, a connection between nodes on the tree structure is point to point, and communications between facing nodes are executed by matching settings between facing ports of the facing nodes. The node receives predetermined data including a predetermined condition from a communication device located at an upper position on the tree structure and exchanges a communication parameter in the predetermined data for a communication parameter of the node when the communication parameter of the node matches the predetermined condition by the decision of the node and sends the predetermined data including the exchanged communication parameter to another communication device located lower than the node on the tree structure.

According to another aspect of the present invention, there is provided a communication device located at the lowest position on a tree structure in a data transferring system in which a data transferring route has the tree structure, a connection between nodes on the tree structure is point to point, and communications between facing nodes are executed by matching settings between facing ports of the facing nodes. The communication device receives predetermined data including a predetermined condition from a node located at an upper position on the tree structure and exchanges a communication parameter in the predetermined data for a communication parameter of the communication device when the communication parameter of the communication device matches the predetermined condition by the decision of the communication device, and sends the predetermined data including the exchanged communication parameter to another communication device located at the uppermost position on the tree structure.

[Effect of the Invention]

According to an embodiment of the present invention, a method, which detects information such as the device number of each port of nodes located from the uppermost position to the lowest position on a tree structure, can be realized by hardware without using software. Therefore, the information detecting processes can be simplified.

In addition, according to the embodiment of the present invention, a method, which detects a communication parameter, for example, the maximum value or the minimum value of the communication parameter, of each port of nodes located from the uppermost position to the lowest position on a tree structure, can be realized by hardware without using software. Therefore, the communication parameter detecting processes can be simplified.

### BRIEF DESCRIPTION OF THE DRAWINGS

Other objects, features and advantages of the present invention will become more apparent from the following detailed description when read in conjunction with the accompanying drawings, in. which:

FIG. 1 is a block diagram showing a configuration of an existing PCI system;

FIG. 2 is a block diagram showing a configuration of a PCI Express system;

FIG. 3 is a block diagram showing a PCI Express platform in a desktop/a mobile computer;

FIG. 4 is a schematic diagram showing a configuration of physical layers in a case of N=×4 (N is the number of lanes of which a link is composed);

FIG. 5 is a schematic diagram showing a lane connection example between devices;

FIG. 6 is a block diagram showing an example of a logical structure of a switch;

FIG. 7A is a block diagram showing existing PCI architecture;

FIG. 7B is a block diagram showing PCI Express architecture;

FIG. 8 is a block diagram showing a layered structure of the PCI Express architecture;

FIG. 9 is a diagram showing a format example of a TLP (transaction layer packet);

FIG. 10 is a diagram showing a configuration memory space of PCI Express;

FIG. 11 is a schematic diagram explaining a concept of virtual channels;

FIG. 12 is a diagram explaining a format example of a DLLP (data link layer packet);

FIG. 13 is a schematic diagram showing a byte striping example in a ×4 link;

FIG. 14 is a diagram explaining a definition of link states L0, L0s, L1, and L2;

FIG. 15 is a timing chart showing a control example of power source management in the link states;

FIG. 16 is a block diagram showing a configuration of a digital copying machine according to an embodiment of the present invention;

FIG. 17 is a block diagram showing a data transferring system based on the PCI Express standard which is used by the digital copying machine shown in FIG. 16;

FIG. 18 is a flowchart showing processes which are executed by a root complex in a route search;

FIG. 19 is a flowchart showing processes which are executed by an upstream side port of a switch in the route search;

FIG. 20 is a flowchart showing processes which are executed by a downstream side port of the switch in the route search;

FIG. 21 is a flowchart showing processes which are executed by an end point in the route search;

FIG. 22 is a block diagram showing the data transferring system in which a parameter search is executed;

FIG. 23 is a flowchart showing processes which are executed by the root complex in the parameter search;

FIG. 24 is a flowchart showing processes which are executed by the ports of the switch in the parameter search; and

FIG. 25 is a flowchart showing processes which are executed by the port of the end point in the parameter search.

### DESCRIPTION OF THE PREFERRED EMBODIMENT

[Best Mode of Carrying Out the Invention]

A best mode of carrying out the present invention is described with reference to the accompanying drawings.

In the following, first, details of the PCI Express standard are explained in “Outline of the PCI Express Standard” to “Details of Architecture of PCI Express”, and subsequently, “Digital Copying Machine” according to an embodiment of the present invention is explained.

[Outline of the PCI Express Standard]

The embodiment of the present invention utilizes PCI Express being one of the high speed serial buses, and as a premise of the embodiment of the present invention, the outline of the PCI Express Standard is explained by using an extract of Non-Patent Document 1. In this, the high speed serial bus signifies an interface that can transmit data at a high speed (approximately over 100 Mbps) by serial transmission with the use of one transmission line.

PCI Express is a bus standardized as a standard extended bus capable of being used in all computers as a successor to PCI, and has features, such as low voltage differential signal transmission, independent communication channels for reception and transmission in point to point, packetized split transaction, and high scalability depending on difference of link structures.

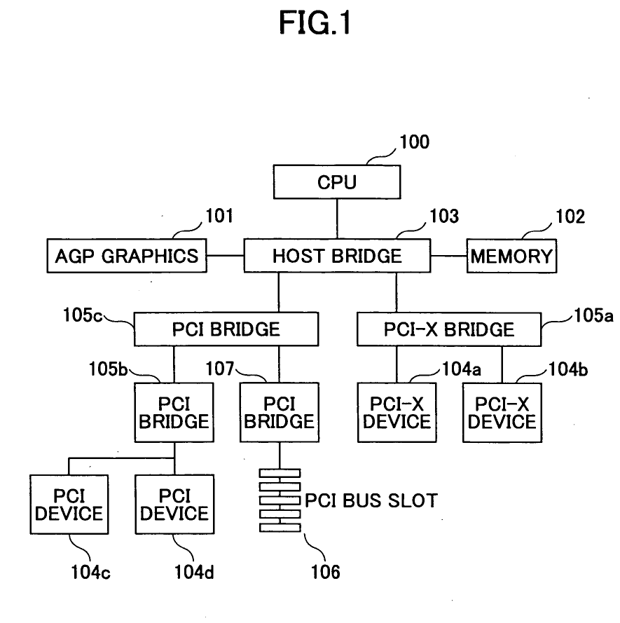

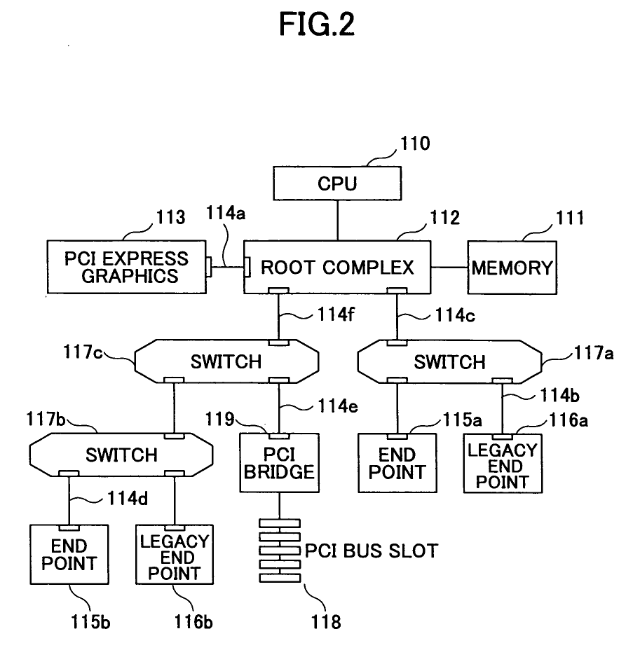

FIG. 1 is a block diagram showing a configuration of an existing PCI system. FIG. 2 is a block diagram showing a configuration of a PCI Express system. In the existing PCI system shown in FIG. 1, a tree structure is formed. In the tree structure, PCI-X devices 104a and 104b (of the upward compatibility standard of PCI) are connected to a host bridge 103, to which a CPU 100, an AGP graphics 101, and a memory 102 are connected, via a PCI-X bridge 105a. Further, a PCI bridge 105b to which PCI devices 104c and 104d are connected and a PCI bridge 107 to which PCI-bus slots 106 are connected are connected to the host bridge 103 via a PCI bridge 105c.

In the PCI Express system shown in FIG. 2, a tree structure is also formed. In the tree structure, a PCI Express graphics (port) 113 is connected to a root complex 112, to which a CPU 110 and a memory 111 are connected, by a PCI Express link 114a; a switch 117a, to which an end point 115a and a legacy end point 116a are connected by PCI Express links 114b, is connected to the root complex 112 by a PCI Express link 114c; a switch 117b, to which an end point 115b and a legacy end point 116b are connected by PCI Express links 114d, and a PCI bridge 119, to which PCI bus slots 118 are connected, are connected to a switch 117c by PCI Express links 114e; and the switch 117c is connected to the root complex 112 by a PCI Express link 114f.

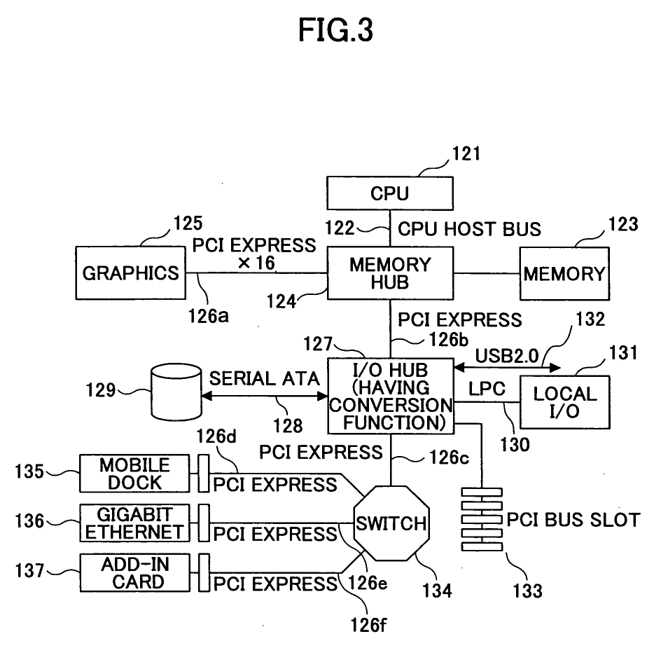

FIG. 3 is a block diagram showing a PCI Express platform in a desktop/a mobile computer. The PCI Express platform shown in FIG. 3 is an example which is assumed to be actually used. In FIG. 3, a CPU 121 is connected to a memory hub 124 (corresponding to a root complex), to which a memory 123 is connected, by a CPU host bus 122. A graphics (port) 125 is connected to the memory hub 124 by a PCI Express link 126a of ×16. An I/O hub 127 having a conversion function is connected to the memory hub 124 by a PCI Express link 126a. Storage 129 is connected to the I/O hub 127 by, for example, a serial ATA (serial AT attachment) 128. A local I/O 131 is connected to the I/O hub 127 by an LPC (low pin count) connector 130, and a USB 2.0 132 and PCI bus slots 133 are connected to the I/O hub 127. Further, a switch 134 is connected to the I/O hub 127 by a PCI Express link 126c, a mobile dock 135 is connected to the switch 134 by a PCI Express link 126d, a gigabit Ethernet LAN 136 is connected to the switch 134 by a PCI Express link 126e, and an add-in card 137 is connected to the switch 134 by a PCI Express link 126f.

That is, in the PCI Express system, conventional buses, such as a PCI bus, a PCI-X bus, and an AGP bus are replaced by the PCI Express buses, and bridges (not shown) are used to connect the existing PCI/PCI-X devices. The connections between chip sets are executed by PCI Express connections, and existing buses, such as an IEEE 1394 (not shown), the Serial ATA 128, and the USB 2.0 132 are connected to the PCI Express buses by the I/O hub 127.

[Configuration Elements of PCI Express]

A. Port/Lane/Link

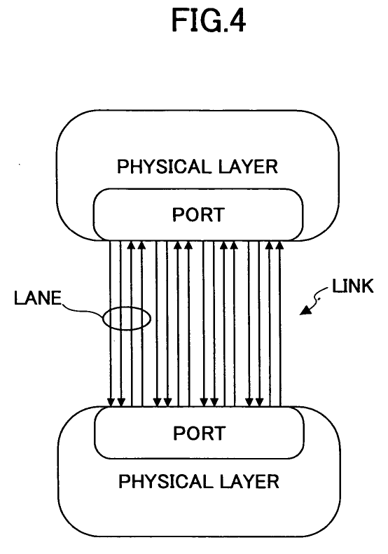

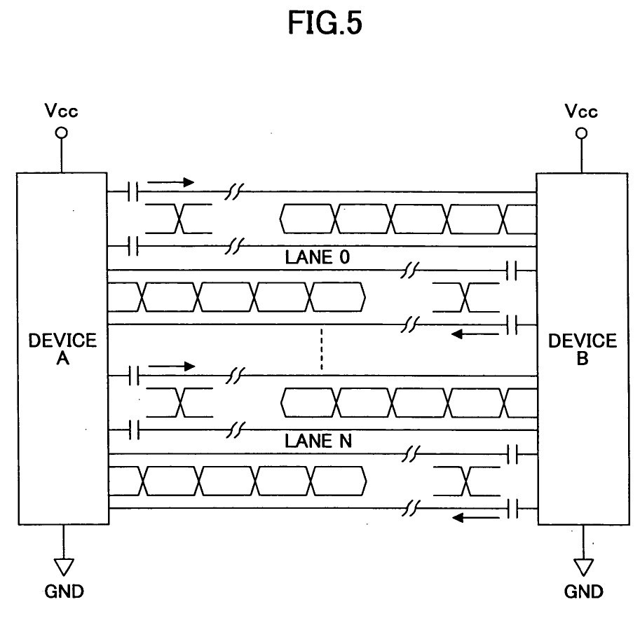

FIG. 4 is a schematic diagram showing a configuration of physical layers in a case of N=×4 (N is described below). Ports are physically in the same semiconductor device and are a set of transmitters/receivers forming links and signify interfaces which connect components logically one to one (point to point). The transfer rate is, for example, 2.5 Gbps in one direction (for the future, 5 Gbps and 10 Gbps are assumed). A lane is a set of two pairs of differential signals of, for example, 0.8 V, and is composed of a pair of transmission side signals (2 pieces) and a pair of reception side signals (2 pieces). A link is a group of lanes connecting the two ports and a dual simplex communication bus between components (devices). A “×N link” is composed of N lanes and N=1, 2, 4, 8, 16, and 32 are defined in the current standard. In FIG. 4, a case of ×4 link is shown. FIG. 5 is a schematic diagram showing a lane connection example between devices. As shown in FIG. 5, when the lane width N connecting devices A and B is variable, a scalable band width can be obtained.

B. Root Complex

The root complex 112 (refer to FIG. 2) is located in the upper most position of the I/O structure and connects a CPU and a memory subsystem to I/Os. In many cases, as shown in FIG. 3, the root complex is described as a memory hub in a block diagram. The root complex 112 (the memory hub 124) has one or more PCI Express ports (root ports), and each PCI Express port forms an independent I/O layer domain. In FIG. 2, rectangles in the root complex 112 are the PCI Express ports. The I/O layer domain may be a simple end point (for example, a case of the side of the end point 115a in FIG. 2) or may be formed by many switches and end points (for example; a case of the side of the end point 115b and the switches 117b and 117c).

C. End Point

The end point (115, 116) is a device which has a configuration space header of type 00h and is specifically a device other than a bridge. There are a legacy end point and a PCI Express end point (simply an end point) in the end points. The PCI Express end point is a BAR (base address register) and basically does not request an I/O port resource or an I/O request due to this. Further, the PCI Express end point does not support a lock request. The above are big differences between the legacy end point and the PCI Express end point.

D. Switch

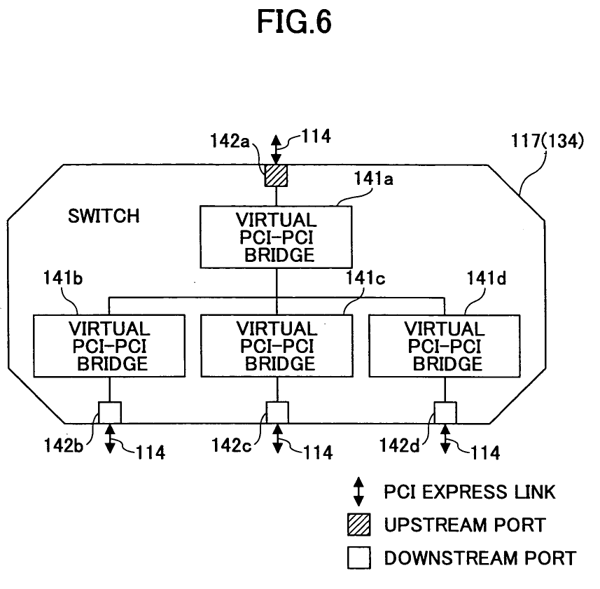

The switch (117, 134) connects two or more ports and executes packet routing among the ports. FIG. 6 is a block diagram showing an example of a logical structure of the switch. As shown in FIG. 6, the switch is recognized as a group of virtual PCI-PCI bridges 141 (141a to 141d) from configuration software. In FIG. 6, arrows show the PCI Express links 114, 126 (114b to 114f, 126c to 126f) and the reference numbers 142a to 142d show ports. The port 142a is an upstream port near the root complex and the ports 142b to 142d are downstream ports far from the root complex.

E. PCI Express Link 114e to PCI Bridge 119

The PCI Express link 114e to the PCI bridge 119 gives a connection from PCI Express to PCI/PCI-X. With this, the existing PCI/PCI-X devices can be used on the PCI Express system.

[Layered Architecture]

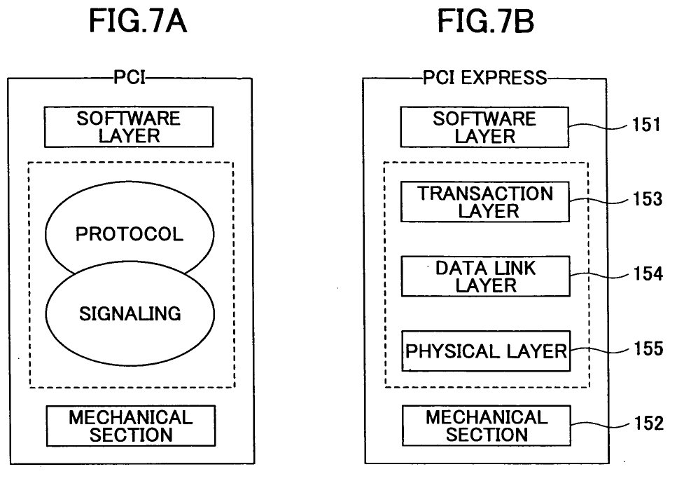

FIG. 7A is a block diagram showing existing PCI architecture. FIG. 7B is a block diagram showing PCI Express architecture. As shown in FIG. 7A, the existing PCI architecture has a structure in which the protocol closely relates to the signaling and does not have the concept of layers. However, as shown in FIG. 7B, the PCI Express architecture has a layered structure and the specification of each layer is defined, similar to the general communication protocol and InfiniBand (registered trademark). That is, the PCI Express architecture has a structure in which a transaction layer 153, a data link layer 154, and a physical layer 155 are disposed between a software layer 151 located in the uppermost position and a mechanical section 152 located in the lowest position. With this structure, the module property of each layer is secured, scalability can be given, and each module can be reused. For example, when a new signal coding system is used or a new transmission medium is used, the data link layer 154 and the transaction layer 153 can be used as they are and only the physical layer 155 is changed.

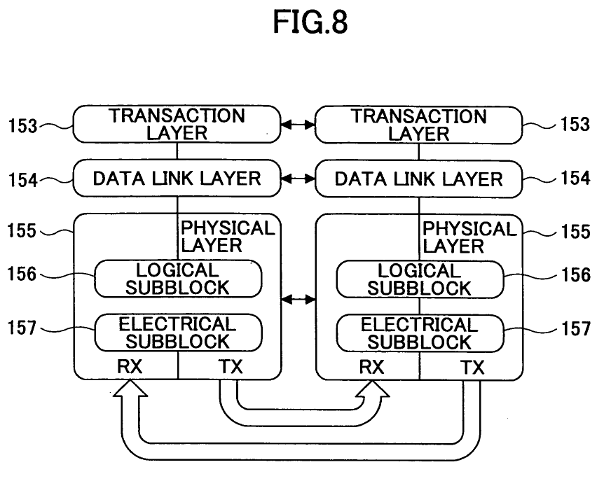

The center of the PCI Express architecture is the transaction layer 153, the data link layer 154, and the physical layer 155. Referring to FIG. 8, each layer is explained. FIG. 8 is a block diagram showing the layered structure of the PCI Express architecture.

A. Transaction Layer 153

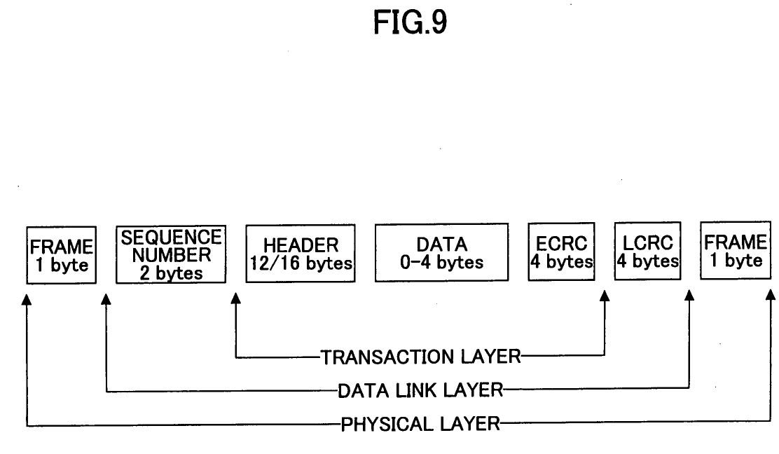

The transaction layer 153 is located in the uppermost position and has a function that assembles and separates TLPs (transaction layer packets). The TLP is used for transference of transactions, such as read/write, and various events. In addition, the transaction layer 153 executes flow control using a credit for the TLP. FIG. 9 is a diagram showing a format example of the TLP. In FIG. 9, an outline of the TLP is shown in relation to the layers 153 to 155. The details of the TLP are explained below.

B. Data Link Layer 154

The main role of the data link layer 154 is to ensure data completeness of the TLP by error detection/correction (retransmission) and execute link management. Exchanging packets for the link management and the flow control are executed between the data link layers 154. These packets are called DLLPs (data link layer packets) so as to distinguish them from the TLPs.

C. Physical Layer 155

The physical layer 155 includes circuits necessary for interface operations, such as a driver, an input buffer, a parallel to serial/serial to parallel converter, a PLL circuit, and an impedance matching circuit. In addition, the physical layer 155 has a function to initialize/maintain the interface as a logic function. Further, the physical layer 155 has a role which makes the data link layer 154/the transaction layer 153 independent from signal technology being used in the actual link.

In this, a technology called an embedded clock is used for a hardware structure of PCI Express, where timing of the clock is embedded in data signals without using clock signals, and a clock is extracted based on a cross point of data signals at the reception side.

[Configuration Space]

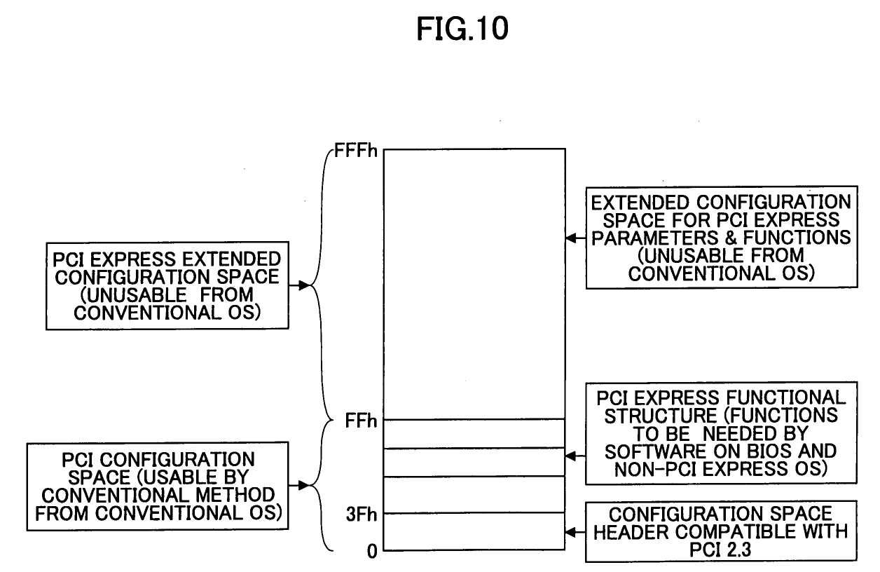

FIG. 10 is a diagram showing a configuration memory space of PCI Express. PCI Express has a configuration space like the conventional PCI, the configuration space of the conventional PCI is 256 bytes; however, as shown in FIG. 10, the configuration space of the PCI Express is extended to 4096 bytes. With this configuration space, enough space is secured for a device such as a host bridge which will need many device intrinsic register sets in the future. In PCI Express, access to the configuration space is executed by access (configuration read/write) to a flat memory space, and bus/device/function/register numbers are mapped in a memory register.

From a BIOS or a conventional OS, a method using an I/O port can access the first 256 bytes in the configuration space, as a PCI configuration space. A function which converts conventional access into PCI Express access is installed in the host bridge. The range from 00h to 3Fh is a configuration header compatible with PCI 2.3. With this, a conventional OS and software can be used as they are except for functions extended by PCI Express. That is, the software layer 151 in PCI Express succeeds to load/store architecture (a processor directly accesses an I/O register) which maintains the compatibility with the existing PCI. However, when functions extended by PCI Express, such as synchronized transfer, RAS (reliability, availability, and serviceability) functions, are used, it is required to access the PCI Express extended space of 4K bytes.

In this, as PCI Express, various form factors are assumed; however, as specific examples, there are an add-in card, a plug-in card (Express card), a mini PCI Express card, and so on.

[Details of PCI Express Architecture]

The transaction layer 153, the data link layer 154, and the physical layer 155 being the center of the PCI Express architecture are explained in detail.

A. Transaction Layer 153

As described above, the main role of the transaction layer 153 is to assemble and separate TLPs between the upper software layer 151 and the lower data link layer 154.

Aa. Address Space and Transaction Type

In PCI Express, in addition to a memory space (for data transfer to another memory space), an I/O space (for data transfer to another I/O space), a configuration space (for setting up and configuration of a device), which are supported by the conventional PCI, a message space is added, that is, four address spaces are defined. The message space is used for transmission (exchange) of messages, such as event notification in band and a general message between devices of PCI Express, and an interrupt request and acknowledgement is transferred by using the message as a virtual wire. Further, a transaction type is defined in each of the address spaces. The memory space, the I/O space, and the configuration space are read/write types, and the message space is a basic type (including a vendor definition).

Ab. TLP (Transaction Layer Packet)

PCI Express executes communications in a packet unit. In the format of the TLP shown in FIG. 9, the length of the header is 3DW (DW signifies double words and 3DW is 12 bytes) or 4DW (16 bytes). In the header, information, such as the format of the TLP (the length of the header and the existence of a payload), the transaction type, a traffic class (TL), an attribute, and a payload length, is included. The maximum payload length in a packet is 1024 DW (4096 bytes).

ECRC is used to ensure the completeness of data in end to end, and is 32 bits CRC in a part of the TLP. When in a switch, if an error occurs in the TLP, the error cannot be detected by LCRC (link CRC) because the LCRC is recalculated in the TLP where the error occurs; therefore, the ECRC is installed.

In requests, there is a request that needs a complete packet and a request that does not need the complete packet.

Ac. TC (Traffic Class) and VC (Virtual Channel)

Upper software can give priority to traffic by using the TC. For example, transferring image data can be given priority in transferring the image data and network data. The TC has eight classes TC0 to TC7.

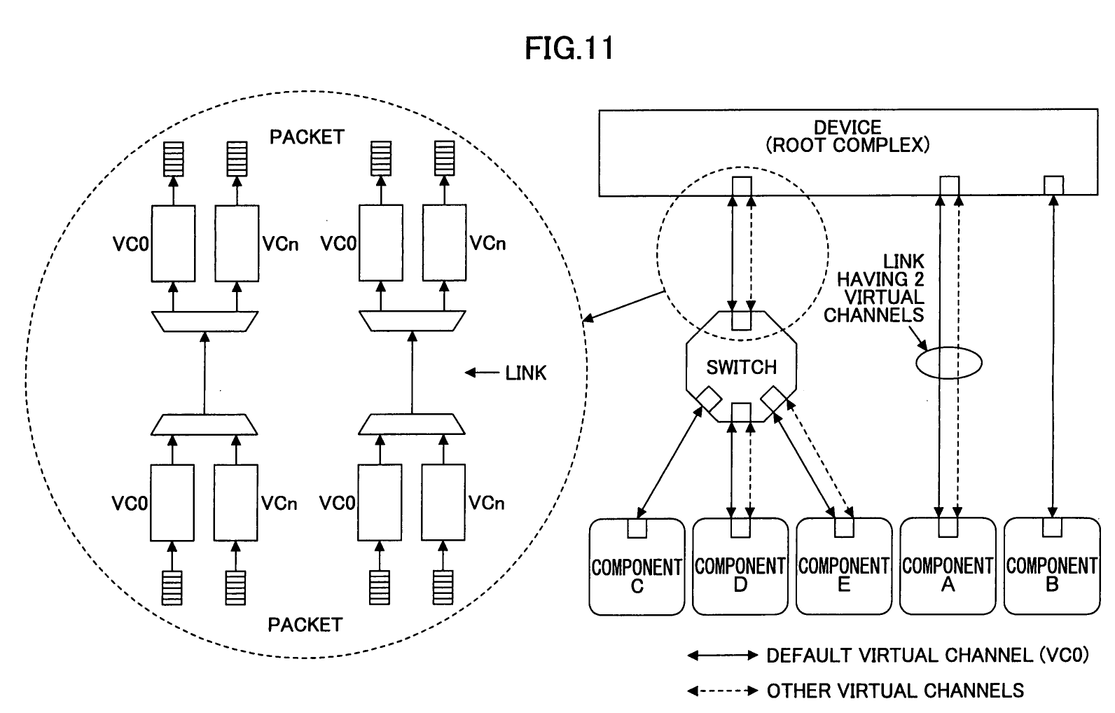

Each of VCs is an independent virtual communication bus and has a resource (buffer and queue). The independent virtual communication buses are mechanisms which use plural independent data flow buffers using the same link in common. FIG. 11 is a schematic diagram explaining the concept of the VCs. As shown in FIG. 11, the VCs execute independent flow control. Even when a buffer of a VC is full, data can be transferred by another VC. That is, one link can be effectively used by dividing the physical one link into plural VCs. For example, as shown in FIG. 11, in a case where a link from a root complex (device) is divided into plural devices (components) via a switch, priority of traffic to each device (component) can be controlled. VC0 is indispensable and other VCs (VC1 to VC7) are installed corresponding to a tradeoff of cost and performance. In FIG. 11, a continuous arrow line shows a default VC (VC0) and a broken arrow line shows other VCs (VC1 to VC7).

In the transaction layer 153, the TC is mapped on the VC. When the number of VCs is small, one or more TCs can be mapped on one VC. In a simple case, it is considered that each TC is mapped on each VC one to one and all TCs are mapped on the VC0. The mapping of TC0 on VC0 is indispensable (fixed), and the other mapping is controlled by the upper software. The software can control the priority by utilizing the TCs.

Ad. Flow Control

FC (flow control) is executed to establish transfer order by avoiding an overflow in a reception buffer. The flow control is executed point to point between links, not end to end. Consequently, a packet reaching a final destination (completer) cannot be acknowledged by the flow control.

The flow control in PCI Express is executed by a credit base. That is, the following mechanism is used. The empty state of a reception side buffer is confirmed before starting the data transmission and overflow and underflow in the buffer are avoided. In other words, the reception side notifies a transmission side of buffer capacity (credit value) at the time of initializing the link, and the transmission side compares the credit value with the length of packets to be transmitted. When the credit value has remaining capacity, the packets are transmitted. There are six types of credits.

Exchanging the information of the flow control is executed by using DLLP (data link layer packet) of the data link layer 154. The flow control is applied only to the TLP and is not applied to the DLLP. Therefore, the DLLP can always be transmitted/received.

B. Data Link Layer 154

As described above, the main role of the data link layer 154 is to provide an exchanging function of the TLPs between two components on a link with high reliability.

Ba. Handling of TLPs

The data link layer 154 adds a sequence number of 2 bytes to its head and an LCRC (link CRC) of 4 Bytes to its tail of the TLP received from the transaction layer 153, and gives it to the physical layer 155 (refer to FIG. 9). The TLPs are stored in a retry buffer and retransmitted to a destination until an acknowledgment is received from the destination. When transmission failure of the TLPs continues, the data link layer 154 decides that the link is abnormal and requires the physical layer 155 to execute retraining of the link. When the training of the link fails, the state of the data link layer 154 is shifted to be inactive.

The sequence number and the LCRC of the TLP received from the physical layer 155 of the transmission side are inspected, and when they are normal, the TLP is sent to the transaction layer 153; when they are abnormal, the reception side requires the transmission side to retransmit the TLP.

Bb. DLLP (Data Link Layer Packet)

A packet generated by the data link layer 154 is called a DLLP, and the DLLP is exchanged between the data link layers 154. The DLLP has the following types:

1. Ack/Nak (reception confirmation and retry (retransmission) of TLP)

2. InitFC1/InitFC2/UpdateFC (initialization and update of Flow Control)

3. Power Source Management

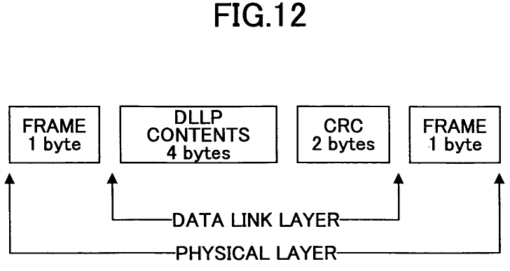

FIG. 12 is a diagram explaining a format example of the DLLP. As shown in FIG. 12, the length of the DLLP is 6 bytes and is composed of DLLP contents of 4 bytes (a DLLP type of 1 byte for showing a type and intrinsic information of the type of 3 bytes) and a CRC of 2 bytes.

C. Logical Subblock 156 in Physical Layer 155

The main role of the logical subblock 156 in the physical layer 155 is to convert a packet received from the data link layer 154 into a packet which an electric subblock 157 can transmit (refer to FIG. 8). Further, the logical subblock 156 has a function of controlling/managing the physical layer 155.

Ca. Data Encoding and Parallel to Serial Conversion

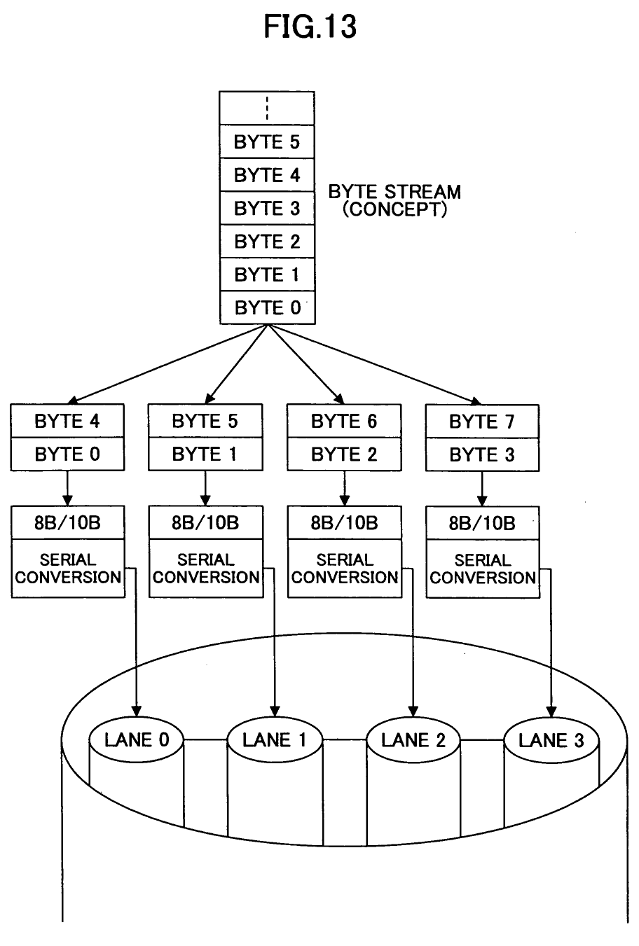

In PCI Express, in order not to remain in a sequence of “0”s or “1”s, that is, in order not to continue without a cross point for a long time, 8B/10B conversion is used for data encoding. FIG. 13 is a schematic diagram showing a byte striping example in a ×4 link. As shown in FIG. 13, serial conversion is applied to the converted data and data from an LSB are transmitted in order on the lane. When plural lanes exist (a case of the ×4 link is shown in FIG. 13), data are allocated to each lane in a byte unit before encoding. In this case, at first sight, this looks like a parallel bus; however, transferring is independently executed in each lane, consequently, skewing being a problem in the parallel bus can be greatly reduced.

Cb. Power Source Management and Link State

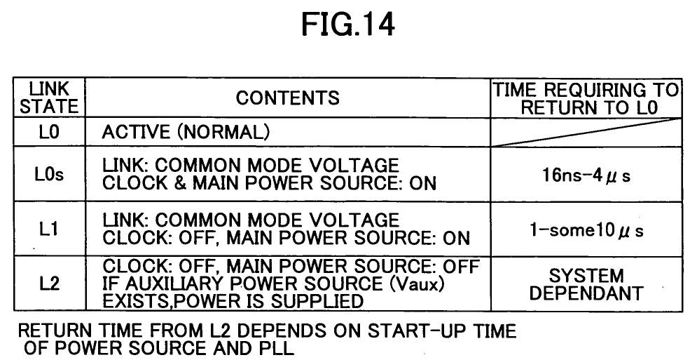

FIG. 14 is a diagram explaining the definition of link states L0, L0s, L1, and L2. As shown in FIG. 14, in order to make power consumption of links low, the link states L0, L0s, L1, and L2 are defined.

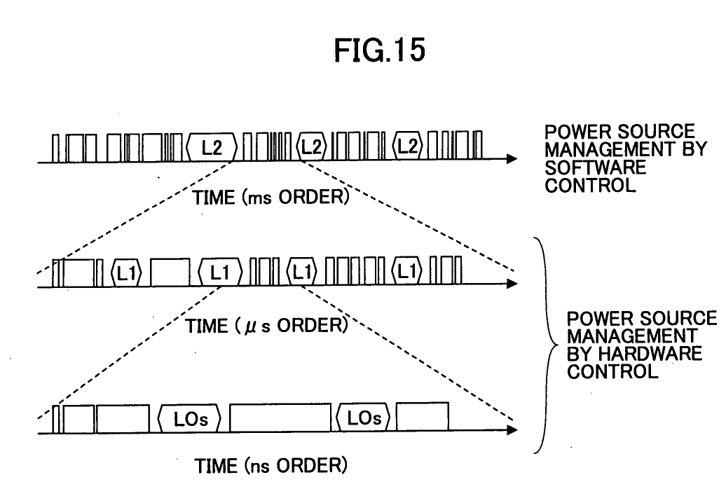

The link state L0 is a normal mode and the power consumption is gradually lowered when the link state is changed from the L0s to L2; however, time requiring to return to the link state L0 becomes longer. FIG. 15 is a timing chart showing a control example of power source management in the link states. As shown in FIG. 15, when the power source management by a hardware control is executed in addition to power source management by software control, the power consumption can be lowered to be as small as possible.

D. Electrical Subblock 157 in Physical Layer 155

The main role of the electrical subblock 157 in the physical layer 155 is to transmit data serialized by the logical subblock 156 to a lane, to receive data from a lane, and to send the received data to the logical subblock 156 (refer to FIG. 8).

Da. AC Coupling

A capacitor for AC coupling is mounted in the transmission side of the link. With this, it is not necessary that a DC common mode voltage be the same in the transmission side and the reception side. Therefore, in the transmission side and the reception side, mutually different designing, a different specification of a semiconductor device, and a different power voltage can be used.

Db. De-Emphasis

As described above, in PCI Express, by the 8B/10B encoding, data are processed so that a sequence of “0”s or “1”s does not persist. However, there is a case where a sequence of “0”s or “1”s persists (at maximum 5). In this case, it is stipulated that the transmission side execute de-emphasis transfer. When the same polarity bits continue, it is necessary that a noise margin of a signal received at the reception side be obtained by lowering the differential voltage level (amplitude) by 3.5±0.5 dB from the second bit. This is called the de-emphasis. By the frequency dependent attenuation in the transmission line, since-changing bits have high frequency components, the waveform of the reception side becomes small by the attenuation; however, in unchanging bits, the high frequency components are few and the waveform of the reception side becomes relatively large. Therefore, the de-emphasis is applied to make the waveform at the reception side constant.

[Digital Copying Machine]

Next, a digital copying machine according to an embodiment of the present invention is explained.

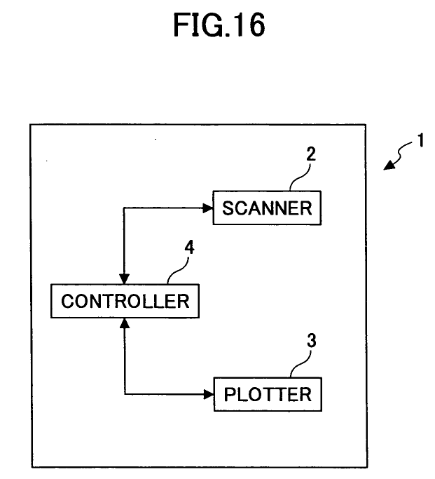

FIG. 16 is a block diagram showing a configuration of the digital copying machine according to the embodiment of the present invention. As shown in FIG. 16, a digital copying machine 1 according to the embodiments of the present invention includes a scanner 2 that reads image data of a manuscript, a plotter 3 that forms an image on a medium such as a paper based on the image data read by the scanner 1, and a controller 4 that totally controls the digital copying machine 1. The digital copying machine 1 is an electronic apparatus of the present invention. As printing systems of the image data by the plotter 3, there are various systems, such as an electro-photographic system, an ink-jet system, a sublimation thermal transcription system, a sliver film photographic system, a direct thermo sensitive recording system, and a melting thermal transcription system, and any one of them can be used.

The digital copying machine 1 executes internal communications by using a data transferring system based on the PCI Express standard. In this case, the controller 4 is a root complex and the scanner 2 and the plotter 3 are end points.

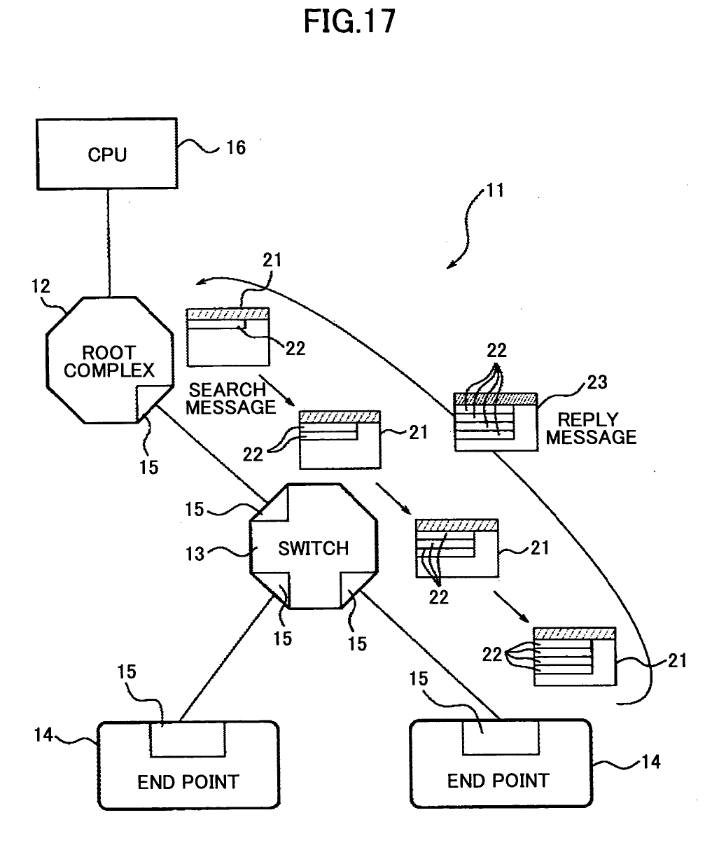

FIG. 17 is a block diagram showing a data transferring system 11 based on the PCI Express standard which is used by the digital copying machine 1 shown in FIG. 16. As shown in FIG. 17, in the data transferring system 11, a data transferring route has a tree structure, a connection between nodes on the tree structure is “point to point”, and communications between the facing nodes are executed by matching settings between facing ports 15 of the facing nodes. In the tree structure, a root complex 12 is located at the uppermost position as a communication device, a switch 13 is located lower than the root complex 12 as a communication device and end points 14 are located at the lowest positions as communication devices. The reference number 15 indicates ports of the communication devices and the reference number 16 is a CPU of the root complex 12.

In the data transferring system 11 having the above configuration, a route search can be executed on the tree structure. In the following, first, the route search is explained.

When initializing the data transferring system 11, regularly, or upon receiving a request from the CPU 16, the root complex 12 broadcasts a search message 21 being a predetermined message to the lower position communication devices on the tree structure at predetermined timing.

When a port 15 receives and confirms the search message 21, the port 15 adds predetermined information of the port 15, specifically, such as the device number 22 of the port 15, to the data payload part of the search message 21 and sends the search message 21 to a node located at a lower position on the tree structure. In FIG. 17, it is shown that the number of the device numbers 22 added to the search message 21 is increased every time the search message 21 passes through the port 15.

When an end point 14 located at the lowest position on the tree structure receives the search message 21, the end point 14 sends a reply message 23 being a predetermined message to the root complex 12 located at the uppermost, position on the tree structure. The device numbers 22 added to the search message 21 which the end point 14 receives are attached to the reply message 23.

With the above processes, the root complex 12 can collect the predetermined information, such as the device numbers 22 of the ports 15 by a simple method without depending on software.

Next, in the above, processes which are executed by each element on the tree structure are explained in detail.

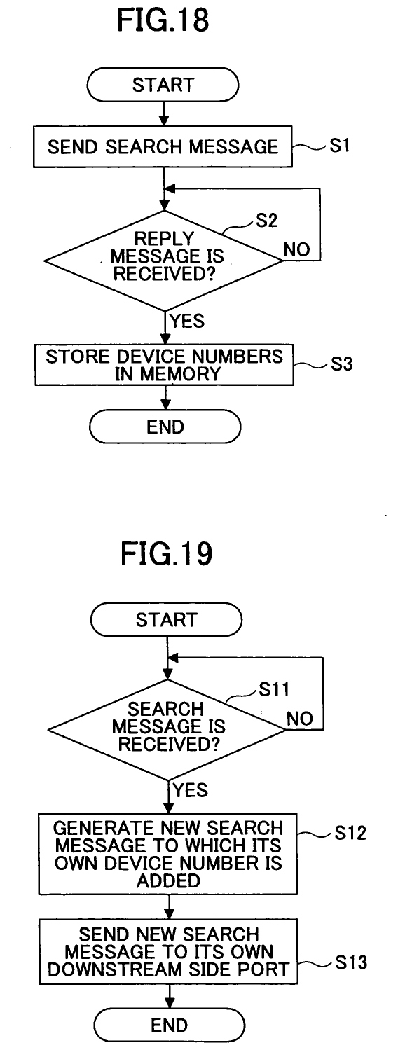

FIG. 18 is a flowchart showing processes which are executed by the root complex 12 in the route search. First, the root complex 12 generates a search message 21 and sends the search message 21 to a node located at a lower position on the tree structure by a broadcast (step S1). Then, the root complex 12 waits for a reply message 23 from an end point 14, and when the root complex 12 receives the reply message 23 (Yes in step S2), the root complex 12 stores device numbers 22 included in the reply message 23 in a predetermined memory (step S3) and the root complex 12 establishes a state so that the CPU 16 can always refer to the device numbers 22.

FIG. 19 is a flowchart showing processes which are executed by the upstream side port 15 of the switch 13 in the route search. When the upstream side port 15 of the switch 13 receives a search message 21 from the root complex 12 (Yes in step S11), the upstream side port 15 generates a new search message 21 to which the device number 22 of its own port 15 is added (step S12). Further, the upstream side port 15 of the switch 13 sends the newly generated search message 21 to the downstream side port 15 of the switch 13 (step S13).

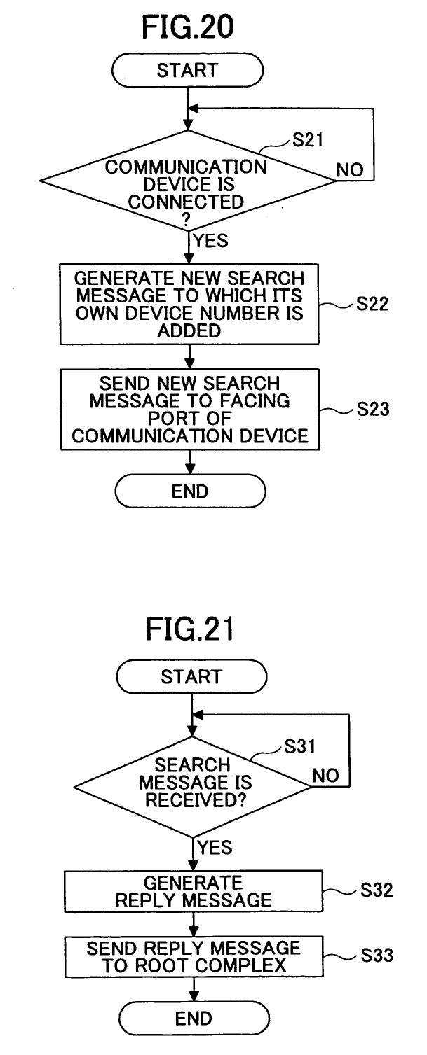

FIG. 20 is a flowchart showing processes which are executed by the downstream side port 15 of the switch 13 in the route search. The downstream side port 15 of the switch 13 decides whether a communication device is connected to its own port 15 (step S21), and when a communication device is connected (Yes in step S21), the port 15 generates a new search message 21 to which the device number 22 of its own port 15 is added (step S22). Further, the downstream side port 15 of the switch 13 sends the newly generated search message 21 to a facing port 15 of the communication device (step S23).

FIG. 21 is a flowchart showing processes which are executed by an end point 14 in the route search. When an end point 14 receives a search message 21 (Yes in step S31), the end point 14 generates a reply message 23 to which the device number 22 of the end point 14 is added 21 (step S32). Further, the end point 14 sends the generated reply message 23 to the root complex 12 (step S33).

Next, a parameter search which is executed in the data transferring system 11 is explained.

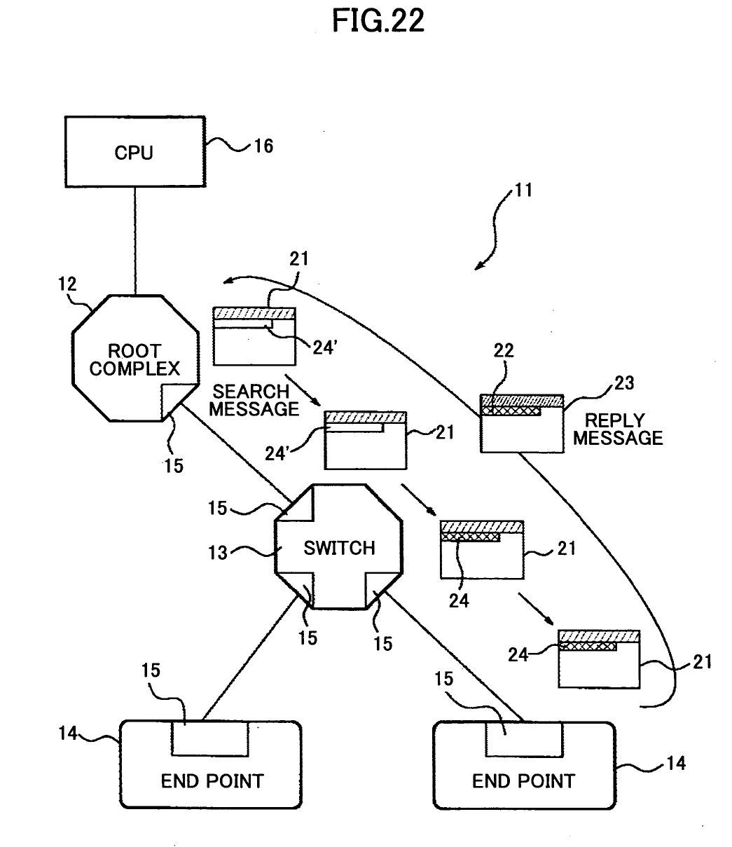

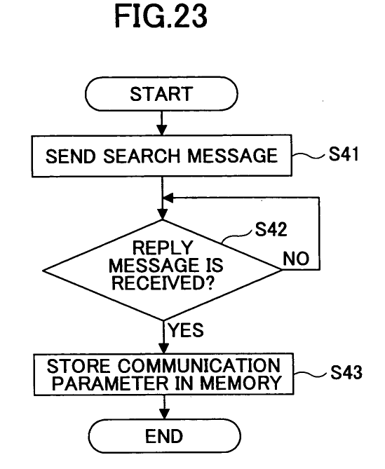

FIG. 22 is a block diagram showing the data transferring system 11 in which the parameter search is executed. As described above, the root complex 12 sends a search message 21 being predetermined data to a specific end point 14 when the CPU 16 requests, like at the start-up time of the data transferring system 11.

In the data transferring system 11, a port 15 receives the search message 21 and confirms it, and the port 15 decides whether a communication parameter 24 of its own port 15 matches a condition included in the search message 21. That is, it is decided whether the maximum value or the minimum value of the communication parameter 24 (the maximum payload size, the number of virtual channels, and so on) matches the condition. When the communication parameter 24 matches the condition, the port 15 exchanges a communication parameter 24′ which has been added to the data payload part of the search message 21 for (the maximum value or the minimum value of) the communication parameter 24 and stores the exchanged communication parameter 24 and sends the communication parameter 24 to the specific end point 14.

When an end point 14 located at the lowest position on the tree structure receives the search message 21, the end point 14 sends a reply message 23 being predetermined data to the root complex 12 located at the uppermost position on the tree structure. The communication parameter 24 having been added to the search message 21 which the end point 14 receives is attached to the reply message 23.

By the above processes, the root complex 12 can collect a necessary communication parameter 24 by a simple method without using software.

Next, processes which are executed by each element on the tree structure in the parameter search are explained in detail.

FIG. 23 is a flowchart showing processes which are executed by the root complex 12 in the parameter search. First, the root complex 12 generates a search message 21 and sends the search message 21 to a specific end point 14 (step S41). Then the root complex 12 waits for a reply message 23 from the end point 14 (step S42). When the root complex 12 receives the reply message 23 (Yes in step S42), the root complex 12 stores a communication parameter 24 included in the reply message 23 in a predetermined memory (step S43) and the root complex 12 establishes a state so that the CPU 16 can always refer to the communication parameter 24.

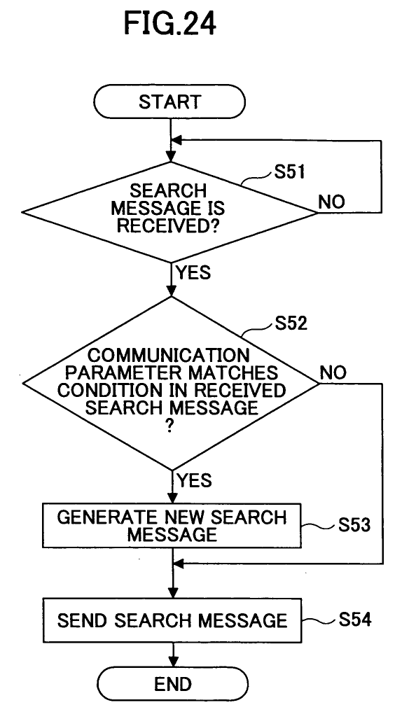

FIG. 24 is a flowchart showing processes which are executed by the ports 15 of the switch 13 in the parameter search. When a port 15 of the switch 13 receives the search message 21 from the root complex 12 (Yes in step S51), the port 15 of the switch 13 decides whether the communication parameter 24 of its own port 15 matches a condition included in the received search message 21 (step S52). When the communication parameter 24 matches the condition (Yes in step S52), the port 15 of the switch 13 generates a new search message 21 in which the communication parameter 24′ having been added to the payload part of the received search message 21 is exchanged for the communication parameter 24 of its own port 15 (step S53) and sends the new search message 21 to the downstream side port 15 of the switch 13 (step S54). When the communication parameter 24 does not match the condition (No in step S52), the upstream side port 15 of the switch 13 sends the received search message 21 to the downstream side port 15 of the switch 13 (step S54). The same processes described above-are executed in the downstream side port 15 of the switch 13 and the downstream side port 15 sends a new search message or the received search message 21 to a facing port 15 located at the lower position on the tree structure.

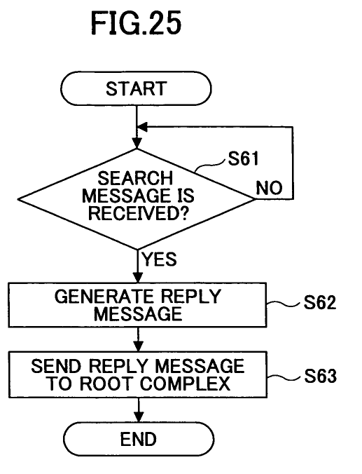

FIG. 25 is a flowchart showing processes which are executed by the port 15 of the end point 14 in the parameter search. When the port 15 of the end point 14 receives the search message 21 (Yes in step S61), the end point 14 generates a reply message 23 including the communication parameter 24 which is included in the received search message 21 (step S62). Then, the end point 14 sends the reply message 23 to the root complex 12 (step S63). At this time, when the communication parameter 24 matching the condition does not exist in each port 15 on the tree structure, a reply message 23 including the communication parameter 24′ is sent to the root complex 12.

Further, the present invention is not limited to the specifically disclosed embodiment, and variations and modifications may be made without departing from the scope of the present invention.

The present invention is based on Japanese Priority Patent Application No. 2005-023687, filed on Jan. 31, 2005, with the Japanese Patent Office, the entire contents of which are hereby incorporated by reference.

What is claimed is:

1. A communication device located at the uppermost position on a tree structure in a data transferring system in which a data transferring route has the tree structure, a connection between nodes on the tree structure is point to point, and communications between facing nodes are executed by matching settings between facing ports of the facing nodes, wherein:
the communication device sends predetermined data to a specific communication device located lower than the communication device on the tree structure, makes the specific communication device add predetermined information of the specific communication device to the predetermined data, and makes the specific communication device send the predetermined data including the predetermined information to a node located lower than the specific communication device.

2. The communication device as claimed in claim 1, wherein:
the communication device sends the predetermined data to the specific communication device by a broadcast.

3. The communication device as claimed in claim 1, wherein:
the communication device is a root complex based on the PCI Express standard.

4. A communication device being a node in a data transferring system in which a data transferring route has a tree structure, a connection between nodes on the tree structure is point to point, and communications between facing nodes are executed by matching settings between facing ports of the facing nodes, wherein:
the node receives data from a communication device located at an upper position on the tree structure, and when the received data are predetermined data, the node adds predetermined information of the node to the predetermined data and sends the predetermined data including the predetermined information to another node located at a lower position on the tree structure.

5. The communication device as claimed in claim 4, wherein:
the communication device is a switch based on the PCI Express standard.

6. A communication device located at the lowest position on a tree structure in a data transferring system in which a data transferring route has the tree structure, a connection between nodes on the tree structure is point to point, and communications between facing nodes are executed by matching settings between facing ports of the facing nodes, wherein:
the communication device receives predetermined data from a node located at an upper position on the tree structure and when the predetermined data instruct to add predetermined information of the communication device to the predetermined data, the communication device generates data in which the predetermined information is added to the predetermined data and sends the generated data to another communication device located at the uppermost position on the tree structure.

7. The communication device as claimed in claim 6, wherein:
the communication device is an end point based on the PCI Express standard.

8. A communication device located at the uppermost position on a tree structure in a data transferring system in which a data transferring route has the tree structure, a connection between nodes on the tree structure is point to point, and communications between facing nodes are executed by matching settings between facing ports of the facing nodes, wherein:
the communication device sends predetermined data including a predetermined condition to a specific communication device located lower than the communication device on the tree structure, makes the specific communication device exchange a communication parameter in the predetermined data for a communication parameter of the specific communication device when the communication parameter of the specific communication device matches the predetermined condition by the decision of the specific communication device, and makes the specific communication device send the predetermined data including the exchanged communication parameter to a node located lower than the specific communication device on the tree structure.

9. The communication device as claimed in claim 8, wherein:
the communication device is a root complex based on the PCI Express standard.

10. A communication device being a node in a data transferring system in which a data transferring route has a tree structure, a connection between nodes on the tree structure is point to point, and communications between facing nodes are executed by matching settings between facing ports of the facing nodes, wherein:
the node receives predetermined data including a predetermined condition from a communication device located at an upper position on the tree structure and exchanges a communication parameter in the predetermined data for a communication parameter of the node when the communication parameter of the node matches the predetermined condition by the decision of the node and sends the predetermined data including the exchanged communication parameter to another communication device located lower than the node on the tree structure.

11. The communication device as claimed in claim 10, wherein:
the communication device is a switch based on the PCI Express standard.

12. A communication device located at the lowest position on a tree structure in a data transferring system in which a data transferring route has the tree structure, a connection between nodes on the tree structure is point to point, and communications between facing nodes are executed by matching settings between facing ports of the facing nodes, wherein:
the communication device receives predetermined data including a predetermined condition from a node located at an upper position on the tree structure, exchanges a communication parameter in the predetermined data for a communication parameter of the communication device when the communication parameter of the communication device matches the predetermined condition by the decision of the communication device, and sends the predetermined data including the exchanged communication parameter to another communication device located at the uppermost position on the tree structure.

13. The communication device as claimed in claim 12, wherein:
the communication device is an end point based on the PCI Express standard.

14. A data transferring system in which a data transferring route has a tree structure, a connection between nodes on the tree structure is point to point, and communications between facing nodes are executed by matching settings between facing ports of the facing nodes, wherein:
a first communication device located at the uppermost position on the tree structure is the communication device as claimed in claim 1;
a second communication device being a node located at a position lower than the first communication device is the communication device as claimed in claim 4; and
a third communication device located at the lowest position is the communication device as claimed in claim 6.

15. A data transferring system in which a data transferring route has a tree structure, a connection between nodes on the tree structure is point to point, and communications between facing nodes are executed by matching settings between facing ports of the facing nodes, wherein:
a first communication device located at the uppermost position on the tree structure is the communication device as claimed in claim 8;
a second communication device being a node located at a position lower than the first communication device is the communication device as claimed in claim 10; and
a third communication device located at the lowest position is the communication device as claimed in claim 12.

16. An electronic apparatus providing the data transferring system as claimed in claim 14.

17. An electronic apparatus providing the data transferring system as claimed in claim 15.
